(19) United States
(12) Patent Application Publication
(10) Pub. No.: US 2026/0101112 A1
(43) Pub. Date: Apr. 9, 2026

(54) ELECTRONIC DEVICE AND PANNING SHOT IMAGE GENERATION METHOD THEREOF

(71) Applicant: ASUSTeK COMPUTER INC., Taipei City (TW)

(72) Inventors: Wei-Lien Tang, Taipei City (TW); Jo-Fan Wu, Taipei City (TW)

(73) Assignee: ASUSTeK COMPUTER INC., Taipei City (TW)

(21) Appl. No.: 19/295,689

(22) Filed: Aug. 10, 2025

(30) Foreign Application Priority Data
Oct. 9, 2024 (TW) 113138426

(51) Int. Cl. H04N 23/698; H04N 23/68

(52) U.S. Cl. CPC H04N 23/698; H04N 23/6811; H04N 23/683

(57) ABSTRACT

Provided are an electronic device and a panning shot image generation method thereof, which includes the following. An image capturing device is configured to capture an image sequence including N short exposure images. N is an integer greater than 1. A target image is selected from the N short exposure images. By performing optical flow estimation, optical flow data between an i-th short exposure image among the N short exposure images and an (i+1)-th short exposure image among the N short exposure images are obtained. Integrated optical flow data is generated based on the optical flow data between the i-th and the (i+1)-th short exposure images. An object position of a target object is determined based on integrated optical flow data. Motion blur processing is performed on the target image based on the object position of the target object and integrated optical flow data to generate a panning shot image.

### CROSS-REFERENCE TO RELATED APPLICATION

This application claims the priority benefit of Taiwan application serial no. 113138426, filed on October 9, 2024. The entirety of the above-mentioned patent application is hereby incorporated by reference herein and made a part of this specification.

### BACKGROUND

### TECHNICAL FIELD

The disclosure relates to a panning shot image generation method and an electronic device using the method.

### DESCRIPTION OF RELATED ART

Panning shot photography is a method of shooting by following a moving object so that the camera and the object are relatively stationary. The shooting method can create a combination of virtual and real effects, making the moving parts (such as the wheels of a car) of the photographed object and the background blurred, while the stationary parts (such as the body of the car) appear clear, showing a strong dynamic effect. Conventionally, panning shot photography generally requires high-standard photography equipment, such as professional cameras and lenses, which not only requires additional expenses for non-professional photography enthusiasts, but also requires relearning the operation of the equipment. In addition, even if the users have appropriate professional photography equipment, successfully using the panning shot technique to shoot requires extensive experience and technology, including correctly setting the shutter speed, aperture size, and focal length, and accurately controlling the movement and rotation timing of the camera during the shooting process, and the degree and stability thereof. In other words, for ordinary non-professional photography users, the technical threshold to produce an ideal panning shot image is quite high.

### SUMMARY

The disclosure provides a panning shot image generation method, which is used for an electronic device including an image capturing device. The method includes the following steps. An image capturing device is configured to capture an image sequence including N short exposure images. N is an integer greater than 1. A target image is selected from the N short exposure images. By performing optical flow estimation, optical flow data between an i-th short exposure image among the N short exposure images and an (i+1)-th short exposure image among the N short exposure images are obtained. i is an integer greater than or equal to 1 and less than N. Integrated optical flow data is generated based on the optical flow data between the i-th short exposure image and the (i+1)-th short exposure image. An object position of a target object is determined based on the integrated optical flow data. Motion blur processing is performed on the target image based on the object position of the target object and the integrated optical flow data to generate a panning shot image.

The disclosure further provides an electronic device, which includes an image capturing device and a processor. The processor is coupled to the image capturing device. The processor is configured to perform the following operations. An image capturing device is configured to capture an image sequence including N short exposure images. N is an integer greater than 1. A target image is selected from the N short exposure images. By performing optical flow estimation, optical flow data between an i-th short exposure image among the N short exposure images and an (i+1)-th short exposure image among the N short exposure images are obtained. i is an integer greater than or equal to 1 and less than N. Integrated optical flow data is generated based on the optical flow data between the i-th short exposure image and the (i+1)-th short exposure image. An object position of a target object is determined based on the integrated optical flow data. Motion blur processing is performed on the target image based on the object position of the target object and the integrated optical flow data to generate a panning shot image.

Based on the above, in the embodiments of the disclosure, the panning shot image with a clear target object and a dynamically blurred background can be generated based on the multiple short exposure images. Therefore, the panning shot image with good panning shot effect can be obtained without using professional photography equipment or professional shooting skills. Based on above, the shooting experience of the user can be improved.

### BRIEF DESCRIPTION OF THE DRAWINGS

FIG. 1 is a block diagram of an electronic device according to an embodiment of the disclosure.

FIG. 2 is a flowchart of a panning shot image generation method according to an embodiment of the disclosure.

FIG. 3 is a schematic diagram of generating optical flow data of two adjacent frames according to an embodiment of the disclosure.

FIG. 4 is a flowchart of the panning shot image generation method according to an embodiment of the disclosure.

FIG. 5 is a schematic diagram of generating integrated optical flow data according to an embodiment of the disclosure.

FIG. 6 is a schematic diagram of determining an object position of a target object according to an embodiment of the disclosure.

FIG. 7 is a schematic diagram of obtaining an object mask according to an embodiment of the disclosure.

FIG. 8 is a flowchart of performing motion blur processing and generating a panning shot image according to an embodiment of the disclosure.

FIG. 9 is a schematic diagram of determining a blur direction and a blur strength of each pixel position according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference signs are used in the drawings and descriptions to represent the same or similar parts. The embodiments are only part of the disclosure and do not disclose all possible implementations of the disclosure. Rather, the embodiments are merely examples of devices and methods within the appended claims of the disclosure.

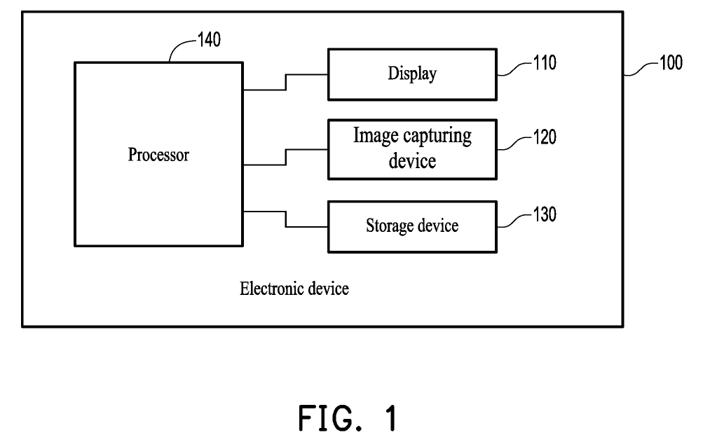

Referring to FIG. 1, an electronic device 100 may include a display 110, an image capturing device 120, a storage device 130, and a processor 140. The electronic device 100 may be, for example, an electronic device with an image capturing function such as a smart phone, a digital camera, a tablet computer, a game console, an electronic wearable device, or a photography device, and the type of the electronic device 100 is not limited thereto.

The display 110 may be various types of displays such as a liquid crystal display (LCD), a light emitting diode (LED) display, or an organic light emitting diode (OLED), and the disclosure is not limited thereto. The display 110 may be used to display the program operation interface of the camera application or the shooting preview screen.

The image capturing device 120 is configured to capture images or videos, and may include lenses, image sensing elements, and other components. The lens may include an optical lens for controlling optical paths. The image sensing element is used to provide image sensing functions. The image sensing element may include a photosensitive element, such as a charge coupled device (CCD), a complementary metal-oxide semiconductor (CMOS) component, or other components, and the disclosure is not limited thereto. The lens may collect imaging light on the image sensing element to achieve the purpose of capturing images.

The storage device 130 is configured to store data such as files, images, instructions, program codes, and software modules, which may be, for example, any type of fixed or removable random access memory (RAM), read-only memory (ROM), flash memory, hard disk, or other similar devices, integrated circuit, or combinations thereof.

The processor 140 is coupled to the display 110, the image capturing device 120, and the storage device 130, for example, the processor 140 may be a central processing unit (CPU) or an application processor (AP), or other programmable general-purpose or special-purpose microprocessors, digital signal processors (DSP), image signal processors (ISP), graphics processing units (GPU), or other similar devices, integrated circuits, or combinations thereof. In some embodiments, the processor 140 may execute instructions or program codes in the storage device 130 to implement each step of the panning shot image generation method in the embodiments of the disclosure.

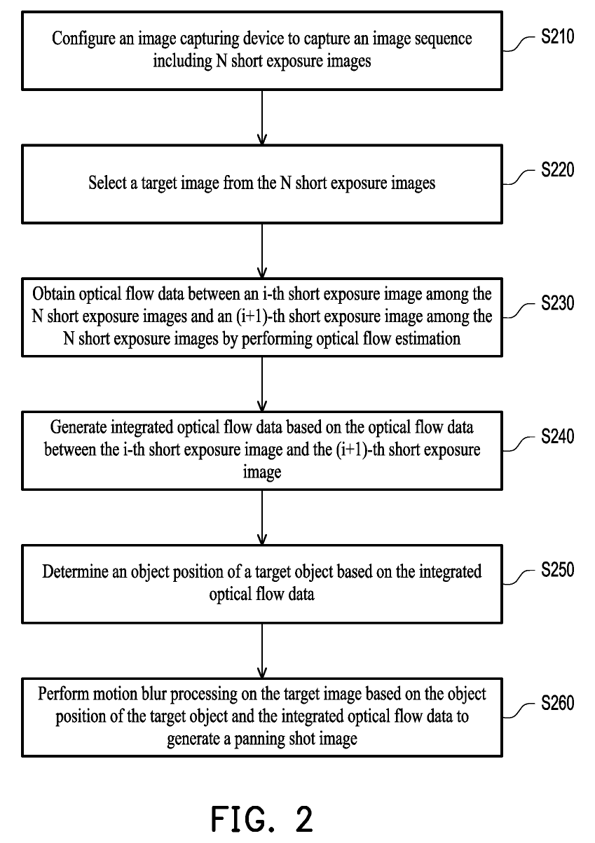

FIG. 2 is a flowchart of a panning shot image generation method according to an embodiment of the disclosure. Referring to FIG. 2, the method in this embodiment may be executed by the electronic device 100 in FIG. 1. The details of each step in FIG. 2 will be described below with reference to the components shown in FIG. 1.

In Step S210, the processor 140 configures the image capturing device 120 to capture an image sequence including N short exposure images. N is an integer greater than 1. In some embodiments, in response to the electronic device 100 receiving a shooting instruction issued by the user, the image capturing device 120 may continuously capture multiple short exposure images. The consecutive N short exposure images in the time sequence form an image sequence according to the shooting order thereof. In some embodiments, the N short exposure images may be generated by the image capturing device 120 shooting according to a high-speed shutter.

In Step S220, the processor 140 selects a target image from the N short exposure images. That is to say, the processor 140 selects one of the N short exposure images as a target image. For example, the processor 140 may select a second-to-last short exposure image in the image sequence as the target image. However, in other embodiments, the processor 140 may select the target image from the N short exposure images according to actual applications and requirements.

In Step S230, the processor 140 obtains optical flow data between an i-th short exposure image among the N short exposure images and an (i+1)-th short exposure image among the N short exposure images by performing optical flow estimation. i is an integer greater than or equal to 1 and less than N. For example, when N=3, the processor 140 may calculate the optical flow data between the first short exposure image and the second short exposure image, and calculate the optical flow data between the second short exposure image and the third short exposure image. Optical flow estimation may calculate the movement speed and direction of each pixel between two consecutive frames of images. That is, the main purpose of optical flow estimation is to track and estimate the movement of each pixel in consecutive images. The disclosure is not limited to the optical flow estimation algorithm, and may be implemented by applying any optical flow estimation algorithm well known to persons with ordinary knowledge in the art, such as the Lucas-Kanade method.

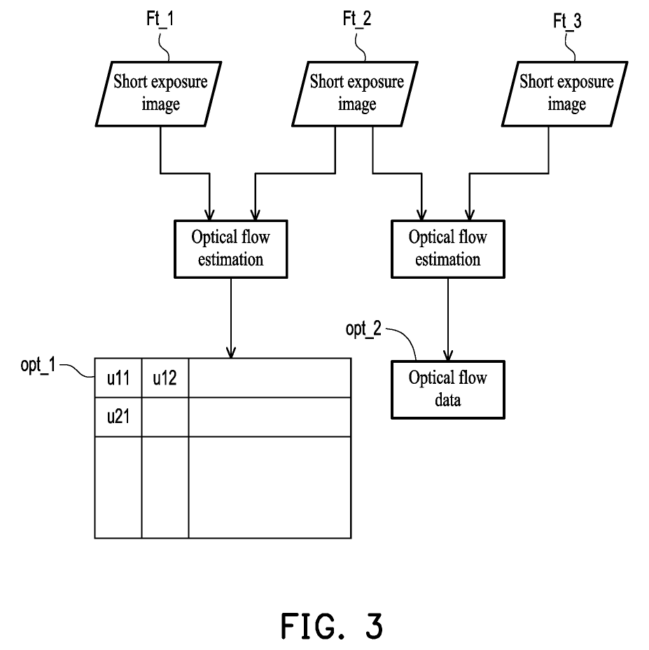

Please refer to FIG. 3, which is a schematic diagram of generating optical flow data of two adjacent frames according to an embodiment of the disclosure. For clear explanation, the example in FIG. 3 is based on N=3, but the disclosure is not limited thereto. The processor 140 may calculate pixel displacement information of each pixel between a first short exposure image Ft_1 and a second short exposure image Ft_2, and obtain first optical flow data opt_1. In the same way, the processor 140 may calculate pixel displacement information of each pixel between the second short exposure image Ft_2 and a third short exposure image Ft_3, and obtain second optical flow data opt_2. The first optical flow data opt_1 and the second optical flow data opt_2 respectively include the pixel displacement information corresponding to each pixel position.

For example, the first optical flow data opt_1 includes pixel displacement information u11 corresponding to a pixel position (1,1), pixel displacement information u12 corresponding to a pixel position (1,2), pixel displacement information u21 corresponding to a pixel position (2,1), and so on. By analogy, when image dimensions of the short exposure images Ft_1 to Ft_3 are W*H, then the first optical flow data opt_1 and the second optical flow data opt_2 are also data matrices of W*H respectively, and each matrix element is pixel displacement information.

In more detail, the pixel displacement information corresponding to each pixel position includes a displacement amount in an X direction and a displacement amount in a Y direction. For example, the pixel displacement information u11 corresponding to the pixel position (1,1) of the first optical flow data opt_1 may include the displacement amount in the X direction and the displacement amount in the Y direction. From another point of view, the pixel displacement information corresponding to each pixel position may be a two-dimensional movement vector including an X component and a Y component. Alternatively, in some embodiments, the pixel displacement information corresponding to each pixel position may include an optical flow angle and an optical flow strength.

In Step S240, the processor 140 generates integrated optical flow data based on the optical flow data between the i-th short exposure image and the (i+1)-th short exposure image. In some embodiments, when N is equal to 2, the processor 140 may determine that the integrated optical flow data is the optical flow data between the i-th short exposure image (that is, the first short exposure image) and the (i+1)-th short exposure image (that is, the 2nd sheet short exposure image). When N is greater than or equal to 3, the processor 140 may generate the integrated optical flow data according to multiple optical flow data matrices. Taking FIG. 3 as an example, when N is equal to 3, the processor 140 may generate the integrated optical flow data based on the first optical flow data opt_1 and the second optical flow data opt_2. In different embodiments, the processor 140 may generate the integrated optical flow data based on averaging or other statistical operations.

In Step S250, the processor 140 determines an object position of a target object based on the integrated optical flow data. In common application scenarios, the target object may be, for example, a car, a motorcycle, a bicycle, a moving animal, or a person. Furthermore, the integrated optical flow data includes pixel displacement information of each pixel position. Therefore, the processor 140 may identify the object position of the target object moving at a relatively high speed in the image based on the pixel displacement information of each pixel position. The object position of the target object may include a target object frame of the target object, which is a region of interest (ROI).

In Step S260, the processor 140 performs motion blur processing on the target image based on the object position of the target object and the integrated optical flow data to generate a panning shot image. When the processor 140 performs motion blur processing, the processor 140 applies a blur effect along a specific direction, thereby producing a visually directional blur result. After confirming the object position of the target object, the processor 140 may perform a directional blur operation on the background area in the target image to generate a panning shot image in which the target object is clear and the background is dynamically blurred. It should be noted that the processor 140 performs motion blur processing based on the integrated optical flow data, so the dynamic blur effect presented in the background area of the panning shot image can be consistent with the real panning shot photos produced by manually moving professional shooting equipment.

It may be seen that the electronic device 100 may use multiple short exposure images to generate the panning shot image. The user does not need to control the camera to follow the movement through experience and technology as in the conventional method. The user only needs to press the shutter button toward the moving target object desired to be photographed, and the electronic device 100 can generate the panning shot photo.

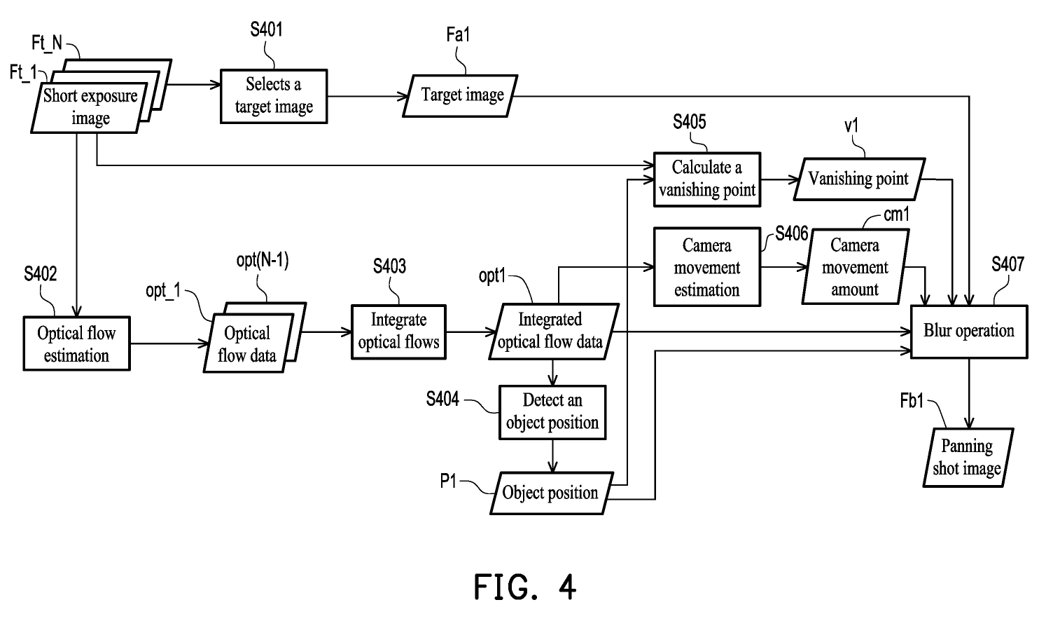

FIG. 4 is a flowchart of the panning shot image generation method according to an embodiment of the disclosure. Referring to FIG. 4, the method in this embodiment may be executed by the electronic device 100 in FIG. 1. The details of each step in FIG. 4 will be described below with the components shown in FIG. 1.

The processor 140 configures the image capturing device 120 to capture an image sequence including N short exposure images Ft_1 to Ft_N. In Step S401, the processor 140 selects a target image Fa1 from the N short exposure images Ft_1 to Ft_N. In Step S402, the processor 140 obtains optical flow data opt_1 to opt_(N-1) between the i-th short exposure image among the N short exposure images Ft_1 to Ft_N and the (i+1)-th short exposure image among the N short exposure images by performing optical flow estimation.. For descriptions of obtaining optical flow data between two adjacent images, reference may be made to the previous embodiments.

In Step S403, the processor 140 generates integrated optical flow data based on the optical flow data between the i-th short exposure image and the (i+1)-th short exposure image. As mentioned above, when N=2, the processor 140 may determine that the integrated optical flow data is the optical flow data between the first short exposure image and the second short exposure image. When N is greater than 2, the optical flow data between the i-th short exposure image and the (i+1)-th short exposure image may include first optical flow data and second optical flow data.

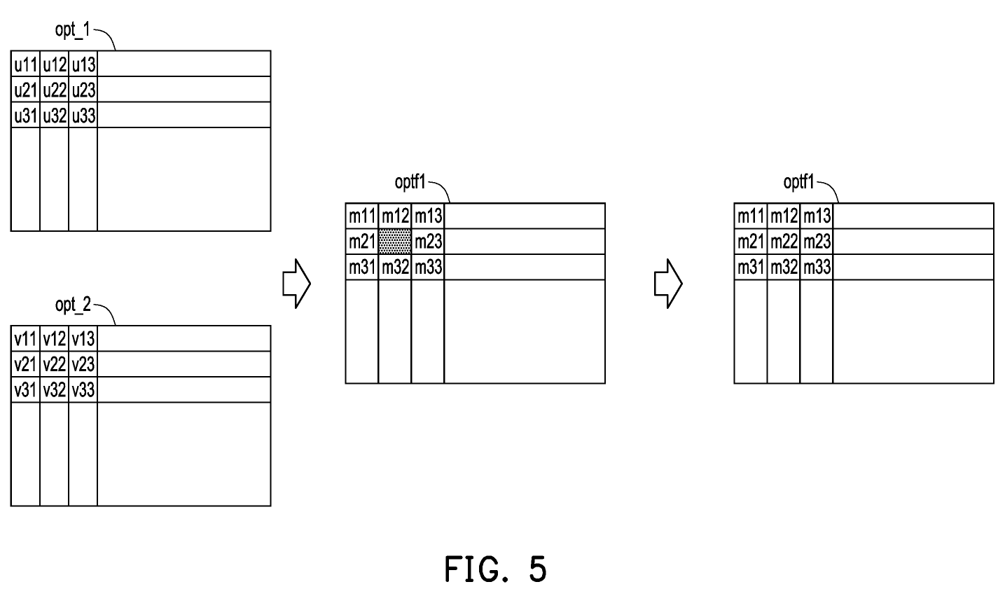

Please refer to FIG. 5, which is a schematic diagram of generating the integrated optical flow data according to an embodiment of the disclosure. Taking N=3 as an example, the processor 140 may obtain the first optical flow data opt_1 and the second optical flow data opt_2. The processor 140 may compare the first optical flow data opt_1 with the second optical flow data opt_2. The first optical flow data opt_1 may include, for example, pixel displacement information u11, u12, u13, u21, u22, u23, u31, u32, and u33 corresponding to different pixel positions. The second optical flow data opt_2 may include, for example, pixel displacement information v11, v12, v13, v21, v22, v23, v31, v32, and v33 corresponding to different pixel positions.

In some embodiments, when the first pixel displacement information corresponding to a pixel position in the first optical flow data opt_1 and the second pixel displacement information corresponding to the same pixel position in the second optical flow data opt_2 meet a matching condition, the processor 140 may perform an average operation on the first pixel displacement information and the second pixel information to generate integrated pixel displacement information corresponding to the same pixel position in integrated optical flow data optf1.

Taking FIG. 5 as an example, the processor 140 may compare the pixel displacement information u11 in the first optical flow data opt_1 with the pixel displacement information v11 in the second optical flow data opt_2. When the pixel displacement information u11 and the pixel displacement information v11 meet a matching condition, the processor 140 may perform an average operation on the pixel displacement information u11 and the pixel displacement information v11 to generate integrated pixel displacement information m11 corresponding to the same pixel position in the integrated optical flow data optf1. In the same way, when the pixel displacement information u12 and the pixel displacement information v12 meet a matching condition, the processor 140 may perform an average operation on the pixel displacement information u12 and the pixel displacement information v12 to generate integrated pixel displacement information m12 corresponding to the same pixel position (1,2) in the integrated optical flow data optf1. In the example of FIG. 5, it is assumed that the integrated pixel displacement information m11, m12, m13, m21, m23, m31, m32, and m33 in the integrated optical flow data optf1 are all generated according to the average operation.

In some embodiments, the processor 140 may compare whether an angle difference between the two pieces of pixel displacement information is lower than a threshold value to determine whether the two pieces of pixel displacement information meet a matching condition. For example, when the angle difference between the optical flow angle of the pixel displacement information u11 and the optical flow angle of the pixel displacement information v11 is lower than the threshold value, the processor 140 may determine that the pixel displacement information u11 and the pixel displacement information v11 meet a matching condition. Alternatively, in some embodiments, the processor 140 may compare whether a displacement difference value in the X direction and a displacement difference value in the Y direction between the two pieces of pixel displacement information are respectively lower than the threshold value to determine whether the two pieces of pixel displacement information meet the matching condition.

That is to say, the processor 140 sequentially determines whether the similarity between two pieces of pixel displacement information at the same pixel position is high enough. When the difference between two pieces of pixel displacement information at the same pixel position is too large, the processor 140 may determine that the two pieces of pixel displacement information do not meet the matching condition. When the two pieces of pixel displacement information meet the matching condition, the processor 140 may perform the average operation on the two pieces of pixel displacement information to obtain the integrated pixel displacement information corresponding to the same pixel position. For example, when the pixel displacement information u11 is (uₓ₁, u_{y1}) and the pixel displacement information v11 is (uₓ₂, u_{y2}), then the integrated pixel displacement information v11 at the same pixel position is ((uₓ₁+uₓ₂)/2, (u_{y1}+u_{y2})/2).

In some embodiments, when the first pixel displacement information corresponding to a pixel position in the first optical flow data opt_1 and the second pixel displacement information corresponding to the same pixel position in the second optical flow data opt_2 do not meet a matching condition, the processor 140 may determine the integrated pixel displacement information corresponding to the same pixel position in the integrated optical flow data optf1 based on reference pixel displacement information corresponding to an adjacent pixel position in the integrated optical flow data.

Taking FIG. 5 as an example, when the pixel displacement information u22 in the first optical flow data opt_1 and the pixel displacement information v22 in the second optical flow data opt_2 corresponding to the same pixel position (2,2) do not meet the matching condition, the processor 140 may obtain multiple pieces of integrated pixel displacement information m11, m12, m13, m21, m23, m31, m32, and m33 (that is, the reference pixel displacement information) adjacent to the pixel position (2,2) in the integrated optical flow data optf1 to determine the integrated pixel displacement information m22 in the integrated optical flow data optf1. In some embodiments, the processor 140 may determine to use the average operation result of the integrated pixel displacement information m11, m12, m13, m21, m23, m31, m32, and m33 as the integrated pixel displacement information m22. Alternatively, the processor 140 may determine to use any one of the integrated pixel displacement information m11, m12, m13, m21, m23, m31, m32, and m33 as the integrated pixel displacement information m22.

In Step S404, the processor 140 determines an object position P1 of the target object based on the integrated optical flow data optf1. Furthermore, the processor 140 may identify the coverage range of pixels with a relatively high movement speed based on the integrated optical flow data optf1, so as to find the object position P1 of the target object based on one or more coverage ranges.

In some embodiments, the processor 140 may perform a statistical operation on the integrated pixel displacement information corresponding to multiple pixel positions in the integrated optical flow data optf1 to determine a filtering threshold value. For example, the processor 140 may perform statistical operations on displacement amounts in the X direction of all pixel positions in the integrated optical flow data optf1 to obtain the third quartile of the displacement amounts in the X direction, and use the third quartile as the filtering threshold value. In the same way, the processor 140 may perform statistical operations on displacement amounts in the Y direction of all pixel positions in the integrated optical flow data optf1 to obtain the third quartile of the displacement amounts in the Y direction, and use the third quartile as the filtering threshold value. That is to say, the processor 140 may obtain the filtering threshold value in the X direction and the filtering threshold value in the Y direction respectively.

In other embodiments, the processor 140 may also perform statistical operations on the displacement amounts in the X direction of all pixel positions in the integrated optical flow data optf1 to obtain the average value and the standard deviation of the displacement amounts in the X direction, and determine that the average value plus the standard deviation is equal to the filtering threshold value in the X direction. In the same way, the processor 140 may also perform statistical operations on the displacement amounts in the Y direction of all pixel positions in the integrated optical flow data optf1 to obtain the average value and the standard deviation of the displacement amounts in the Y direction, and determine that the average value plus the standard deviation is equal to the filtering threshold value in the Y direction.

Afterward, the processor 140 may compare the integrated pixel displacement information of each pixel position in the integrated optical flow data optf1 with the filtering threshold value. That is to say, the processor 140 may determine whether the displacement amount in the X direction of each pixel position in the integrated optical flow data optf1 is greater than the filtering threshold value in the X direction, and determine whether the displacement amount in the Y direction of each pixel position in the integrated optical flow data optf1 is greater than the filtering threshold value in the Y direction.

In some embodiments, the processor 140 may obtain a target object frame of the target object based on the integrated pixel displacement information greater than the filtering threshold value in the integrated optical flow data optf1. In some embodiments, the target object frame of the target object is the object position P1 of the target object. In detail, when the displacement amount in the X direction and the displacement amount in the Y direction of a certain pixel position in the integrated optical flow data optf1 are both greater than the corresponding filtering threshold value, the processor 140 may mark the pixel position as a candidate pixel coordinate. After comparing the integrated pixel displacement information of all pixel positions in the integrated optical flow data optf1 with the filtering threshold value, the processor 140 may obtain multiple candidate pixel coordinates, and determine the object position P1 of the target object based on these candidate pixel coordinates.

In some embodiments, the processor 140 may identify multiple candidate object frames based on the coverage area of integrated pixel displacement information greater than the filtering threshold value. In detail, after comparing the integrated pixel displacement information of all pixel positions in the integrated optical flow data optf1 with the filtering threshold value, the processor 140 may identify candidate pixel coordinates greater than the integrated pixel displacement information of the filtering threshold value, so as to obtain multiple coverage areas based on the multiple connected candidate pixel coordinates. Afterward, the processor 140 may identify multiple candidate object frames surrounding the coverage areas.

Afterward, the processor 140 may select the target object frame of the target object according to the size of each candidate object frame. In some embodiments, the processor 140 may select the candidate object frame with the largest frame area or the longest frame edge as the target object frame of the target object. In addition, in some embodiments, the processor 140 may select the target object frame of the target object based on motion information of each candidate object frame. In some embodiments, the motion information of each candidate object frame may be calculated based on the integrated pixel displacement information corresponding to each candidate pixel coordinate. Furthermore, in some embodiments, the processor 140 may calculate a score of each candidate object frame based on the size and the motion information of each candidate object frame through a weighted scoring mechanism, and then select the target object frame of the target object based on the score of each candidate object frame. For example, the size of each candidate object frame may correspond to a first weight "0.3", and the motion information of each candidate object frame may correspond to a second weight "0.7". The processor 140 may calculate the score of each candidate object frame based on the size and the motion information of each candidate object frame, the first weight "0.3", and the second weight "0.7".

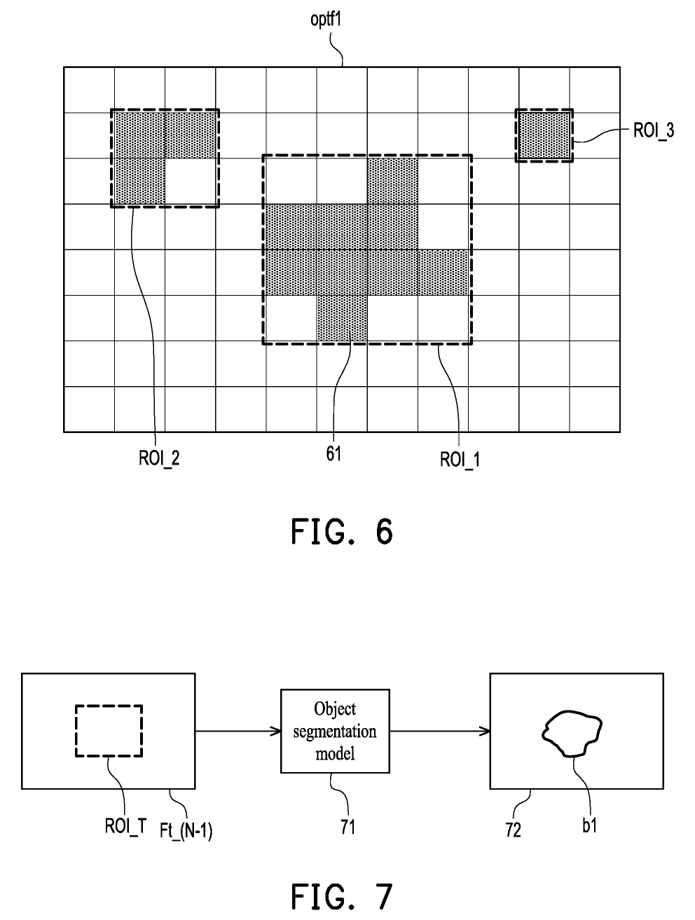

Please refer to FIG. 6, which is a schematic diagram of determining the object position of the target object according to an embodiment of the disclosure. The processor 140 may compare the integrated pixel displacement information of all pixel positions in the integrated optical flow data optf1 with the filtering threshold value, and find the integrated pixel displacement information greater than the filtering threshold value, that is, the integrated pixel displacement information indicated by the dotted net (such as integrated pixel displacement information 61). In the example of FIG. 6, the processor 140 may obtain three coverage areas based on the integrated pixel displacement information greater than the filtering threshold value, and identify three candidate object frames ROI_1, ROI_2, and ROI_3 corresponding to the three coverage areas. Afterward, the processor 140 may identify the candidate object frame ROI_1 with the largest frame area as the target object frame to obtain the object position P1 of the target object.

In some embodiments, the object position P1 of the target object may include an object mask of the target object. The processor 140 may utilize an object segmentation model to obtain the object mask of the target object based on model input information. The object segmentation model is an image segmentation model based on convolutional neural networks. The model input information may include an initial mask or the target object frame of the target object, or at least one coordinate point.

Please refer to FIG. 7, which is a schematic diagram of obtaining the object mask according to an embodiment of the disclosure. The processor 140 may input a local image area defined by a target object frame ROI_T in a certain short exposure image Ft_(N-1) into an object segmentation model 71, and the processor 140 may identify an object boundary b1 of the target object according to the image segmentation result output by the object segmentation model 71. Therefore, the processor 140 may obtain an object mask 72 of the target object according to the object boundary b1 of the target object. The object mask 72 may be used to define the actual edge of the target object, so that the object edge of the target object in the subsequently generated panning shot image can be clearer.

In Step S405, the processor 140 determines a vanishing point v1 of the target object based on the N short exposure images Ft_1 to Ft_N and the object position P1 of the target object. The processor 140 may perform feature point extraction to obtain multiple image feature points within the target object frame in respective short exposure images Ft_1 to Ft_N. Afterward, the processor 140 may determine the vanishing point v1 of the target object based on the image feature points in the respective short exposure images Ft_1 to Ft_N. The disclosure does not limit the algorithm for calculating the vanishing point v1, and the operation may be implemented by applying any vanishing point estimation technique well known to persons with ordinary knowledge in the art.

In Step S406, the processor 140 obtains a camera movement amount cm1 based on the integrated optical flow data optf1. The processor 140 may obtain the camera movement amount cm1 based on the integrated optical flow data optf1 through methods known in the art (such as visual odometry). In some embodiments, the camera movement amount cm1 may be a two-dimensional movement vector.

In Step S407, the processor 140 performs motion blur processing on a target image Fa1 based on the camera movement amount cm1, the vanishing point v1, the integrated optical flow data optf1, and the object position P1 of the target object to generate a panning shot image Fb1. In detail, the processor 140 may correct the integrated optical flow data optf1 based on the camera movement amount cm1 to obtain scene movement information corresponding to each pixel position. The processor 140 may obtain the object range of the moving target object in the image based on the object position P1 of the target object (such as the target object frame or the object mask). Therefore, the processor 140 may determine the motion blur kernel applied to each pixel point in the target image Fa1 based on the known information to generate the panning shot image Fb1 in which the target object is clear and the background has directional dynamic blur.

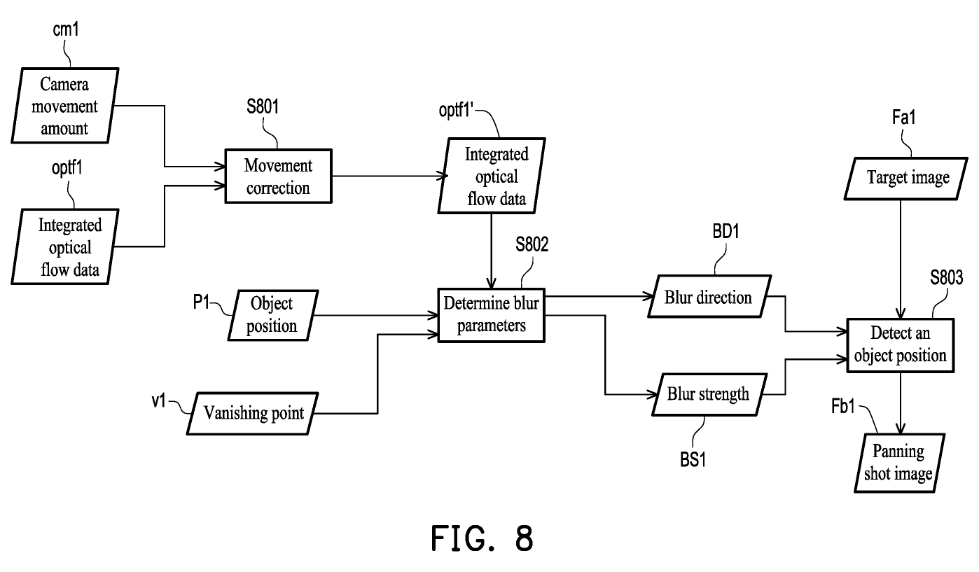

Please refer to FIG. 8, which is a flowchart of performing motion blur processing and generating a panning shot image according to an embodiment of the disclosure. In Step S801, the processor 140 performs a motion correction on the integrated optical flow data optf1 based on the camera movement amount cm1 to obtain a corrected integrated optical flow data optf1'. For example, the processor 140 may obtain the corrected integrated optical flow data optf1' by subtracting an X camera displacement amount and a Y camera displacement amount of the camera movement amount cm1 from the X displacement amount and the Y displacement amount of each pixel position in the integrated optical flow data optf1 respectively.

In Step S802, the processor 140 determines a blur direction BD1 and a blur strength BS1 of each pixel position based on the corrected integrated optical flow data optf1', the vanishing point v1, and the object position P1 of the target object. Furthermore, the processor 140 may determine the blur direction BD1 and the blur strength BS1 of each pixel position based on table lookup or function calculation.

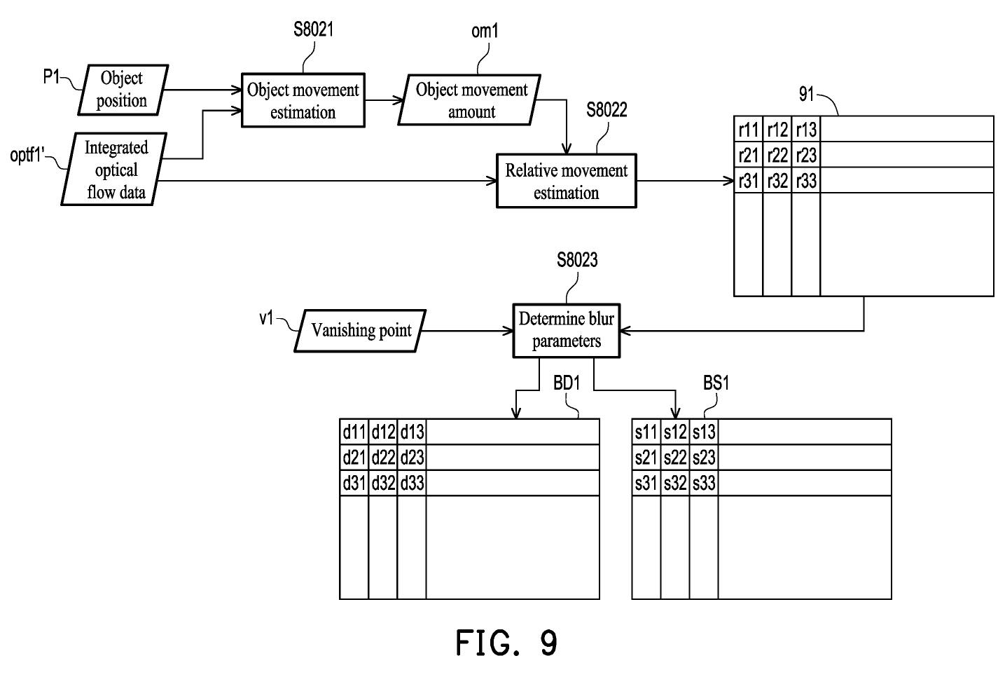

Please refer to FIG. 9, which is a schematic diagram of determining the blur direction and the blur strength of each pixel position according to an embodiment of the disclosure. In Step S8021, the processor 140 determines an object movement amount om1 of the target object based on the object position P1 of the target object and the corrected integrated optical flow data optf1'. In some embodiments, the processor 140 may perform the average operation on all pieces of the integrated pixel displacement information retained by the object mask in the integrated optical flow data optf1' to obtain the object movement amount om1. The object movement amount om1 is also a two-dimensional movement vector.

Next, in Step S8022, the processor 140 subtracts the object movement amount om1 from the integrated pixel displacement information of each pixel position in the corrected integrated optical flow data optf1' to obtain a relative movement amount 91 of each pixel position. The relative movement amount 91 of each pixel position may include relative movement amounts r11, r12, r13, r21, r22, r23, r31, r32, r33, and so on. The relative movement amount 91 may also be expressed as a two-dimensional movement vector. Alternatively, the relative movement amount 91 may be converted into a movement angle and a movement distance. For example, the relative movement amount r11 corresponding to the pixel position (1,1) may be a two-dimensional movement vector. Alternatively, the relative movement amount r11 corresponding to the pixel position (1,1) may be converted into a movement angle and movement distance. That is to say, the relative movement amount 91 of each pixel position represents relative movement information relative to the movement state of the target object.

In Step S8023, the processor 140 determines the blur direction BD1 and the blur strength BS1 of each pixel position based on the relative movement amount 91 and the vanishing point v1 of each pixel position. The blur direction BD1 of each pixel position includes blur directions d11, d12, d13, d21, d22, d23, d31, d32, d33, and so on. The blur strength BS1 of each pixel position includes blur strengths s11, s12, s13, s21, s22, s23, s31, s32, s33, and so on.

In detail, the processor 140 may determine the blur direction d11 and the blur strength s11 of the pixel position (1,1) based on the relative movement amount r11 and the vanishing point v1 of the pixel position (1,1). The processor 140 may determine the blur direction d12 and the blur strength s12 of the pixel position (1,2) based on the relative movement amount r12 and the vanishing point v1 of the pixel position (1,2). The above-mentioned operation continues in the same manner.

It should be noted that the blur direction BD1 of each pixel position may be the kernel blur direction of the motion blur kernel applied to each pixel position. The blur direction BS1 of each pixel position may be the kernel size of the motion blur kernel applied to each pixel position. Furthermore, the processor 140 may determine the kernel blur direction and the kernel size of the motion blur kernel used of each pixel position based on the relative movement amount 91 and the vanishing point v1 of each pixel position.

In some embodiments, the blur strength BS1 of each pixel position is directly related to the distance between each pixel position and the vanishing point v1. That is to say, a distance between a certain pixel position and the vanishing point v1 is positively related to the kernel size of the motion blur kernel applied to the pixel position. That is, the further away from the vanishing point, the stronger the blur effect is; the closer to the vanishing point, the weaker the blur effect is. It may be seen that an embodiment of the disclosure may consider the effect of perspective projection to determine the degree of blur, so that the final result is closer to a real panning shot photo.

In some embodiments, the movement angle of the relative movement amount (for example, the relative movement amount r11) at a certain pixel position may be used to determine the kernel blur direction of the motion blur kernel. The movement distance of the relative movement amount (such as the relative movement amount r11) at a certain pixel position may be used to determine the kernel size of the motion blur kernel. The kernel size of the blur kernel is positively related to the movement distance of the relative movement amount (such as the relative movement amount r11).

In Step S803, the processor 140 performs motion blur processing on the target image Fa1 according to the blur direction BD1 and the blur strength BS1 of each pixel position to generate the panning shot image Fb1. In other words, the processor 140 may perform motion blur processing based on the motion blur kernel specific to each pixel position.

In summary, in the embodiments of the disclosure, the panning shot image with a clear target object and a dynamically blurred background can be generated based on the optical flow estimation results of the multiple short exposure images. Therefore, the panning shot image with good panning shot effect can be obtained without using professional photography equipment or professional shooting skills. Based on above, the shooting experience of the user can be improved. In addition, in an embodiment of the disclosure, the blur strength of motion blur processing can be determined according to the vanishing point, so the panning shot image can be closer to the actual situation and more natural.

Although the disclosure has been described in terms of embodiments, the embodiments are not intended to limit the disclosure. Persons with ordinary knowledge in the relevant technical field may make slight changes and modifications without departing from the spirit and scope of the disclosure. Therefore, the scope of protection of the disclosure shall be determined by the scope of the appended claims.

What is claimed is:

1. A panning shot image generation method used for an electronic device, wherein the method comprises:
configuring an image capturing device to capture an image sequence comprising N short exposure images, wherein N is an integer greater than 1;
selecting a target image from the N short exposure images;
obtaining optical flow data between an i-th short exposure image among the N short exposure images and an (i+1)-th short exposure image among the N short exposure images by performing optical flow estimation, wherein i is an integer greater than or equal to 1 and less than N;
generating integrated optical flow data based on the optical flow data between the i-th short exposure image and the (i+1)-th short exposure image; and
determining an object position of a target object based on the integrated optical flow data;
performing motion blur processing on the target image based on the object position of the target object and the integrated optical flow data to generate a panning shot image.

2. The panning shot image generation method as claimed in claim 1, wherein generating the integrated optical flow data based on the optical flow data between the i-th short exposure image and the (i+1)-th short exposure image comprises:
determining the integrated optical flow data to be the optical flow data between the i-th short exposure image and the (i+1)-th short exposure image in response to N being equal to 2.

3. The panning shot image generation method as claimed in claim 1, wherein the optical flow data between the i-th short exposure image and the (i+1)-th short exposure image comprises first optical flow data and second optical flow data in response to N being greater than 2,
wherein generating the integrated optical flow data based on the optical flow data between the i-th short exposure image and the (i+1)-th short exposure image comprises:
comparing the first optical flow data and the second optical flow data;
in response to first pixel displacement information corresponding to a pixel position in the first optical flow data and second pixel displacement information corresponding to the same pixel position in the second optical flow data meeting a matching condition, performing an average operation on the first pixel displacement information and the second pixel information to generate integrated pixel displacement information corresponding to the pixel position in the integrated optical flow data; and
in response to first pixel displacement information corresponding to a pixel position in the first optical flow data and second pixel displacement information corresponding to the same pixel position in the second optical flow data not meeting the matching condition, determining the integrated pixel displacement information corresponding to the pixel position in the integrated optical flow data based on reference pixel displacement information corresponding to an adjacent pixel position in the integrated optical flow data.

4. The panning shot image generation method as claimed in claim 1, wherein determining the object position of the target object based on the integrated optical flow data comprises:
performing a statistical operation on integrated pixel displacement information corresponding to a plurality of pixel positions in the integrated optical flow data to determine a filtering threshold value;
comparing the integrated pixel displacement information of each of the plurality of pixel positions in the integrated optical flow data with the filtering threshold value; and
obtaining a target object frame of the target object based on integrated pixel displacement information greater than the filtering threshold value in the integrated optical flow data.

5. The panning shot image generation method as claimed in claim 4, wherein obtaining the target object frame of the target object based on the integrated pixel displacement information greater than the filtering threshold value in the integrated optical flow data comprises:
identifying a plurality of candidate object frames based on a coverage area of integrated pixel displacement information greater than the filtering threshold value; and
selecting the target object frame of the target object according to a size of each of the plurality of candidate object frames.

6. The panning shot image generation method as claimed in claim 4, wherein determining the object position of the target object based on the integrated optical flow data further comprises:
configuring an object segmentation model to obtain an object mask of the target object based on model input information, wherein the model input information comprises the target object frame or an initial mask of the target object, or at least one coordinate point.

7. The panning shot image generation method as claimed in claim 1, wherein performing motion blur processing on the target image based on the object position of the target object and the integrated optical flow data to generate the panning shot image comprises:
obtaining a camera movement amount based on the integrated optical flow data;
determining a vanishing point of the target object based on the N short exposure images and the object position of the target object; and
performing motion blur processing on the target image to generate the panning shot image based on the camera movement amount, the vanishing point, the integrated optical flow data, and the object position of the target object.

8. The panning shot image generation method as claimed in claim 7, wherein performing motion blur processing on the target image to generate the panning shot image based on the camera movement amount, the vanishing point, the integrated optical flow data, and the object position of the target object comprises:
performing a motion correction on the integrated optical flow data based on the camera movement amount to obtain corrected integrated optical flow data;
determining blur directions and blur strengths of respective pixel positions based on the corrected integrated optical flow data, the vanishing point, and the object position of the target object; and
performing motion blur processing on the target image to generate the panning shot image according to the blur directions and the blur strengths of the respective pixel positions.

9. The panning shot image generation method as claimed in claim 8, wherein determining the blur directions and the blur strengths of the respective pixel positions based on the corrected integrated optical flow data, the vanishing point, and the object position of the target object comprises:
determining an object movement amount of the target object based on the object position of the target object and the corrected integrated optical flow data;
subtracting the object movement amount from integrated pixel displacement information of the respective pixel positions in the corrected integrated optical flow data to obtain relative movement amounts of the respective pixel positions; and
determining the blur directions and the blur strengths of the respective pixel positions based on the relative movement amounts of the respective pixel positions and the vanishing point.

10. The panning shot image generation method as claimed in claim 9, wherein the blur strengths of the respective pixel positions are positively related to distances between the respective pixel positions and the vanishing point.

11. An electronic device, comprising:
an image capturing device; and
a processor coupled to the image capturing device and configured to:
configuring the image capturing device to capture an image sequence comprising N short exposure images, wherein N is an integer greater than 1;
selecting a target image from the N short exposure images;
obtaining optical flow data between an i-th short exposure image among the N short exposure images and an (i+1)-th short exposure image among the N short exposure images by performing optical flow estimation, wherein i is an integer greater than or equal to 1 and less than N;
generating integrated optical flow data based on the optical flow data between the i-th short exposure image and the (i+1)-th short exposure image; and
determining an object position of a target object based on the integrated optical flow data;
performing motion blur processing on the target image based on the object position of the target object and the integrated optical flow data to generate a panning shot image.
